(19) United States
(12) Patent Application Publication
(10) Pub. No.: US 2008/0068218 A1
(43) Pub. Date: Mar. 20, 2008

(54) Speed limit alert

(76) Inventor: Sarah H Lawson, Battle Creek, MI (US)

Correspondence Address: Sarah Lawson, 25 Highway St., Battle Creek, MI, 49014, US

(21) Appl. No.: 11/447,576

(22) Filed: Sep. 18, 2006

(51) Int. Cl. G08G 1/09

(52) U.S. Cl. 340/905

(57) ABSTRACT

The SPEED LIMIT ALERT is a transmitter & receiver used to monitor the speed limit on highways, freeways & city streets. It alerts the driver in a change in the speed limit. Used correctly it should help reduce the number of tickets & accidents occurring on the roads today due to drivers speeding & not knowing the speed limit.

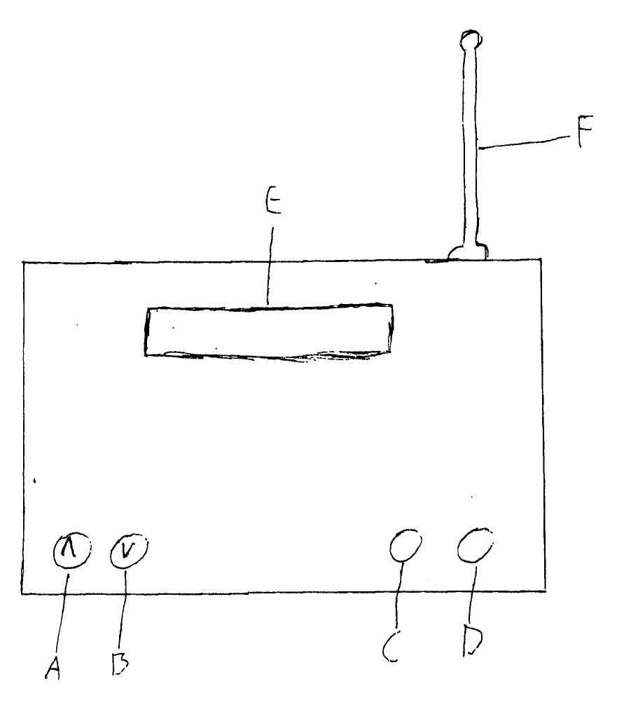

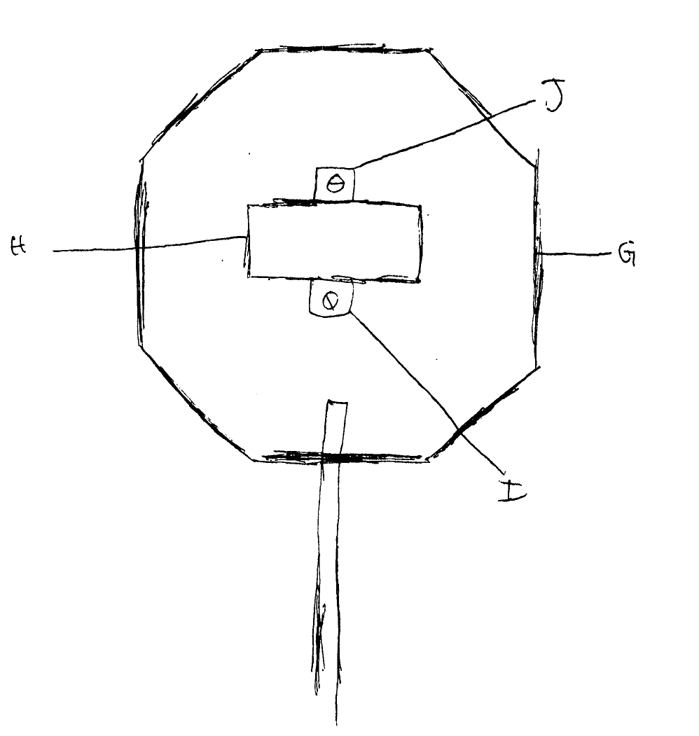

My invention, SPEED LIMIT ALERT, consists of a transmitter box & a receiver box. The transmitter is a box on the back of any sign along the road (highways, freeways, and city streets). It is programmed with that particular areas speed limit. It is reprogrammable, especially in areas where the speed limit changes frequently. It emits a constant signal within 100 feet around it to the speed limit alert receiver in a passing car. The transmitter has a solar battery installed in it to keep it powered. The receiver's antenna receives the signal & displays the speed limit on the display screen. It also says the speed limit out loud for the driver to hear. The receiver also comes with a power button for turning the receiver on & off, buttons to adjust the volume of the voice command & a repeat button to repeat the last speed limit received. The receiver is attached to the cars dashboard. It has wires running from the receiver to the engine to supply it with power. If used, the SPEED LIMIT ALERT monitors the speed limit in an area where a transmitter has been installed & a receiver in a passing car receives it.

A., B. The volume buttons.
C. The repeat button
D. The power button
E. The display screen
F. The antenna
G. The back of the stop sign.
H. The transmitter box.
I., J. The screws holding the transmitter box on.

1. I claim that the speed limit alert is my own idea & design.
